(19) United States
(12) Patent Application Publication
(10) Pub. No.: US 2010/0097228 A1
(43) Pub. Date: Apr. 22, 2010

(54) SYSTEM AND METHOD FOR MONITORING AND/OR NOTIFYING WIRELESS DEVICE USERS OF RADIATION EXPOSURE

(76) Inventors: Paul T. Schultz, Colorado Springs, CO (US); Robert Sartini, Colorado Springs, CO (US); Martin McKee, Herndon, VA (US)

Correspondence Address: VERIZON;PATENT MANAGEMENT GROUP, 1320 North Court House Road, 9th Floor, ARLINGTON, VA, 22201-2909, US

(21) Appl. No.: 12/255,058

(22) Filed: Oct. 21, 2008

(51) Int. Cl. G08B 17/12

(52) U.S. Cl. 340/600

(57) ABSTRACT

A system and method for monitoring and/or notifying wireless device users of radiation exposure includes determining at least one of an amount of radiation and a level of radiation, a wireless device user is exposed to. The system and method may also comprise inputting at least one of a threshold amount of radiation and a threshold level of radiation. The system and method may further comprise comparing at least one of the amount of radiation with the threshold amount of radiation and the level of radiation with the threshold level of radiation. In addition, the system and method may comprise transmitting an alert message based at least in part on a result of the comparison of at least one of the amount of radiation with the threshold amount of radiation and the level of radiation with the threshold level of radiation.

### BACKGROUND INFORMATION

Generally wireless devices operate through transmission of electromagnetic signals over a wireless network which enables a wireless device user to communicate with other wireless device users. Many studies have been conducted regarding or questioning the safety of the wireless devices when held close to the wireless device user's head because of radiation associated with the electromagnetic signals emitted/received by the wireless device. Based on these studies suggest that wireless device users should use other means (e.g., Bluetooth technology, speakers, text message) to communicate with other wireless device users as opposed to holding the wireless device close to the user's head. Currently, wireless devices are configured to transmit at different signal strength under various conditions and/or at various locations and therefore may emit/receive different amounts of radiation. For example, a wireless device may transmit at a higher signal strength (e.g., emit/receive higher amount of radiation) at a location where the signal strength may be weak and/or in an enclosure (e.g., a car or a building). Therefore, a wireless device user may be exposed to various amounts of radiation under different conditions and/or at different locations. Currently, a wireless device user may not be aware of their radiation exposure under various conditions and/or at various locations. Therefore, wireless device users may wish to monitor and/or be notified of radiation emitted from and/or received by the wireless device under various conditions and/or at various locations.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 illustrates a block diagram of a system architecture for monitoring and/or notifying wireless device users of radiation exposure, in accordance with exemplary embodiments;

FIG. 2 illustrates a block diagram of a detection system for a system of monitoring and/or notifying wireless device users of radiation exposure, in accordance with exemplary embodiments; and

FIG. 3 illustrates a flowchart for monitoring and/or notifying wireless device users of radiation exposure, in accordance with exemplary embodiments.

These and other embodiments and advantages will become apparent from the following detailed description, taken in conjunction with the accompanying drawings, illustrating by way of example the principles of the various exemplary embodiments.

### DETAILED DESCRIPTION OF EMBODIMENTS

A system and method may include various exemplary embodiments for monitoring and/or notifying wireless device users of radiation exposure. The system and method may include a detection system for monitoring and/or notifying wireless device users of an amount of radiation exposure (e.g., a total amount of radiation a wireless device user may be exposed to for a period of time). Also, the detection system may monitor and/or notify wireless device users of a level of radiation exposure (e.g., a radiation level a wireless device user may be exposed to for an instant in time). For example, the detection system may be connected to, integrated or otherwise associated with a wireless device (e.g., a wireless telephone or cellular telephone). The detection system may communicate with a service provider through a network, such as a wireless network. The detection system may provide one or more radiation alert messages (e.g., visual, audio, and/or haptic) to wireless device users and/or the service provider to update an amount of radiation exposure and/or a level of radiation exposure associated with the wireless device users. Also, the service provider may provide one or more radiation exposure reports (e.g., electronic mail, instant message, text message, short message service (SMS), multimedia message service (MMS)) periodically to wireless device users based at least in part on wireless device user preferences. The detection system may include one or more radiation sensors in order to determine an amount of radiation exposure and/or a level of radiation exposure associated with the wireless device. In addition, the detection system may monitor and/or notify wireless device users of an amount of radiation exposure and/or a level of radiation exposure. By knowing the amount of radiation exposure a wireless device user is exposed to, the wireless device user may take one or more actions to reduce the amount of radiation exposure and/or a level of radiation exposure. The detection system may alert wireless device users in the event that an amount of radiation exposure exceeds a threshold amount of radiation exposure and/or a level of radiation exposure exceeds a threshold level of radiation exposure.

The description below describes radiation sensors, radiation service portals, wireless devices, service providers and network elements that may include one or more modules, some of which are explicitly shown, others are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but is not limited to, a compact disc (CD), a digital versatile disc (DVD), a floppy disk, a hard drive, read only memory (ROM), random access memory (RAM), as well as other physical media capable of storing software, and/or combinations thereof. The functions described as being performed at various components may be performed at other components, and the various components may be combined and/or separated. Other modifications also may be made.

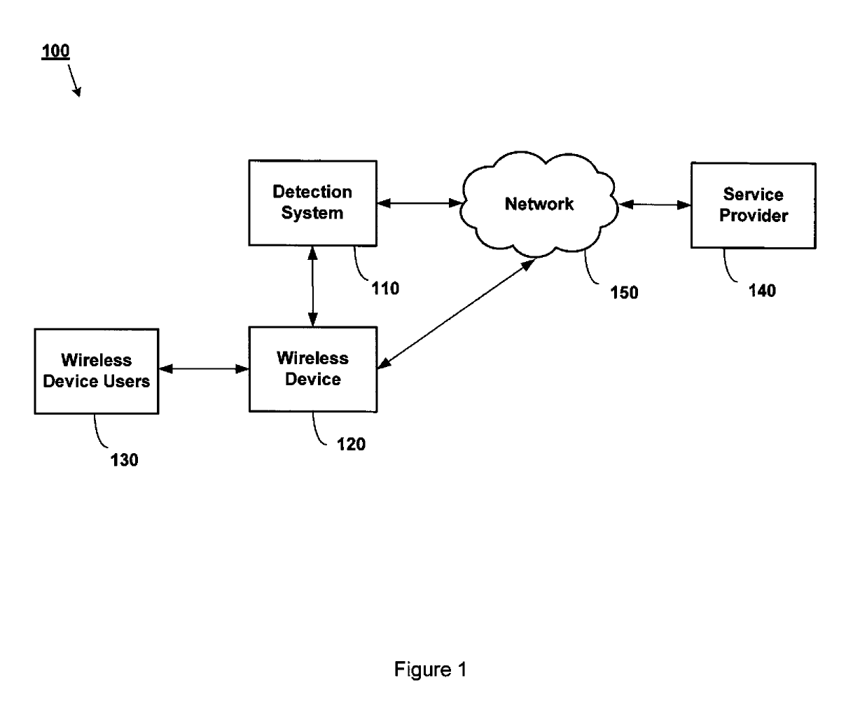

FIG. 1 illustrates a block diagram of a system architecture for monitoring and/or notifying wireless device users of radiation exposure, according to an exemplary embodiment. System 100 illustrates a system architecture for monitoring and/or notifying wireless device users of radiation exposure. As illustrated, a detection system 110 may be coupled to a wireless device 120 and a wireless device user 130 may be associated with the wireless device 120. The detection system 110 may monitor an amount of radiation exposure and/or a level of radiation exposure associated with the wireless device user 130, and may notify the wireless device user 130. For example, the amount of the radiation exposure associated with the wireless device user 130 may be referred to as a total amount of radiation a wireless device user 130 may be exposed to for a period of time (e.g., a call session, a day, a week, a month). The level of radiation exposure associated with the wireless device user 130 may be referred to as a radiation level a wireless device user 130 may be exposed to for an instant in time. The detection system 110 may be coupled to a service provider 140 via a network 150. In an exemplary embodiment, the service provider 140 may provide a graphical user interface (e.g., one or more websites and/or webpages) to allow the wireless device user 130 to input a threshold amount of radiation exposure and/or a threshold level of radiation exposure. Also, the graphical user interface may display a radiation exposure report (e.g., total amount of radiation exposure for a day, a week, a month and/or a year) associated with the wireless device user 130. Also, the wireless device 120 and/or the service provider 140 may provide a predetermined value for a threshold amount of radiation exposure and/or a threshold level of radiation exposure. The detection system 110 may notify the wireless device user 130 in the event that an amount of radiation the wireless device user 130 is exposed to exceeds the threshold amount of radiation exposure and/or a level of radiation the wireless device user 130 is exposed to exceeds the threshold level of radiation exposure.

Detection system 110 may be integrated, coupled to or associated with the wireless device 120. For example, detection system 110 may be an external device that connects to and/or communicates with the wireless device 120. The detection system 110 may be an external device connected to the wireless device 120 via an interface port which may include, without limitation, USB ports, system bus ports, Firewire ports, cable ports, and/or other interface ports to couple the detection system 110 to the wireless device 120. In another exemplary embodiment, the detection system 110 may be an external device that communicates with the wireless device 120 wirelessly. For example, the detection system 110 may communicate with the wireless device 120 via a local area network (LAN). The local area network (LAN) may include, but is not limited to, infrared, Bluetooth™, radio frequency (RF), and/or other methods of wireless communication. In other exemplary embodiments, detection system 110 may be integrated with the wireless device 120. Further, computer code may be stored in a storage medium associated with the wireless device 120 to control and/or operate the detection system 110.

The detection system 110 may include one or more sensors to monitor an amount of radiation the wireless device user 130 may be exposed to and/or a level of radiation the wireless device user 130 may be exposed to. In an exemplary embodiment, the one or more sensors of the detection system 110 may include, but is not limited to, electromagnetic wave sensors, thermal sensors (e.g., heat sensors, bolometer), magnetic sensors (e.g., magnetometer), light sensors (e.g., photodetectors), infrared sensors, proximity sensors, interferometry, scintillometers, Geiger counters, Scintillation counters, and/or other sensors to measure an amount of radiation and/or a level of radiation the wireless device user 130 may be exposed to. In another exemplary embodiment, the detection system 110 may obtain and/or receive radiation data (e.g., an amount of radiation and/or a level of radiation exposure) associated with the wireless device user 130 from the wireless device 120.

Wireless device 120 may include, but is not limited to, a wireless phone system, a digital telephone system, a cordless telephone system, a mobile phone system, a satellite phone system, an IP telephone system and/or any other wireless communication system. According to an exemplary embodiment, wireless device 120 may include, but is not limited to, a computer device, or communications device including, for example, a personal computer (PC), a workstation, a mobile device, a handheld PC, a personal digital assistant (PDA), an alert device, a transceiver, a thin system, a fat system, a network appliance, and/or other similar computing devices.

The detection system 110 may communicate with the service provider 140 via the network 150. The service provider 140 may include one or more telephone service providers for providing communications service over a wireless network and/or a public switch telephone network (PSTN). For example, the service provider 140 may carry a data packet stream (e.g., digital and audio) encapsulated in telephony signals or Internet Protocol (IP) packets transmitted over the network 150. In another exemplary embodiment, the service provider 140 may include one or more Internet service providers for providing the wireless device user 130 access to the Internet over the network 150. The service provider 140 may include one or more processors and/or servers to provide telephone and/or Internet services for the wireless device 120. The service provider 140 may provide one or more websites and/or webpages to allow the wireless device user 130 to interface with the detection system 110 and/or the service provider 140. Also, the service provider 140 may include one or more databases to store wireless device user preferences, data transmitted by the detection system 110 and/or data received from the wireless device user 130.

Detection system 110 may communicate with the service provider 140 through the network 150. The network 150 may be a wireless network, a wired network or any combination of wireless, wired and/or other network. For example, network 150 may include, but is not limited to, wireless LAN, Code Division Multiple Access (CDMA), Time Division Multiple Access (TDMA), Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or any other similar wireless network. In addition, network 150 may include, but is not limited to, telephone line, fiber optics, IEEE Ethernet 802.3, wide area network (WAN), local area network (LAN), global network such as the Internet. Also, network 150 may enable, a wireless communication network, a cellular network, an Intranet, or the like, or any combination thereof. The network 150 may further include one, or any number of the exemplary types of networks mentioned above operating as a stand-alone network or in cooperation with each other.

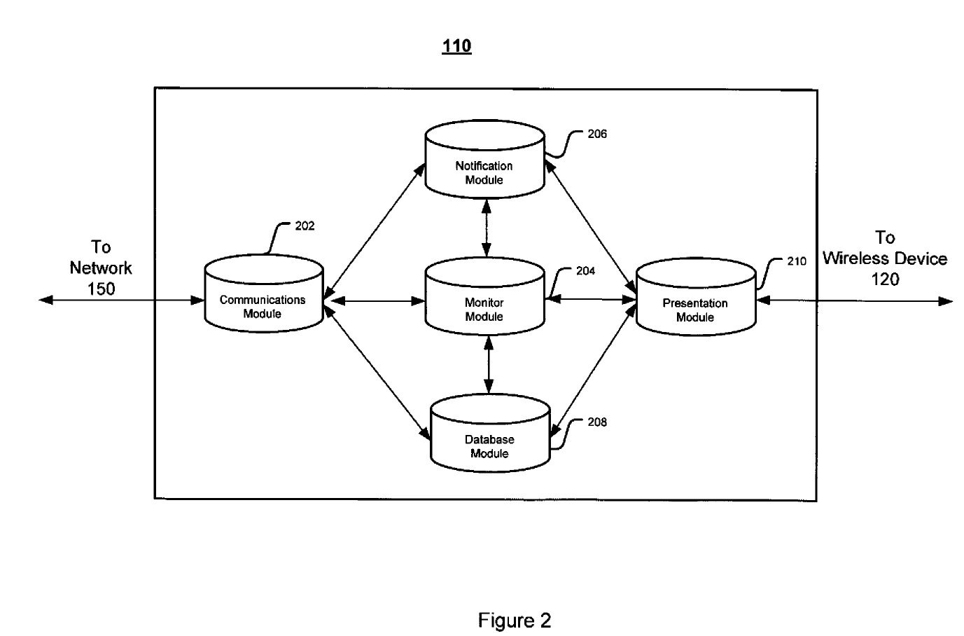

FIG. 2 illustrates a block diagram of a detection system for a system of monitoring and/or notifying wireless device users of radiation exposure, in accordance with exemplary embodiments. In an exemplary embodiment, the detection system 110 may monitor and/or notify an amount of radiation and/or a level of radiation the wireless device user 130 may be exposed to. For example, the service provider 140 may include a communication module 202, a monitor module 204, a notification module 206, a database module 208, and a presentation module 210. It is noted that the modules 202, 204, 206, 208, 210 are exemplary and the functions performed by one or more of the modules may be combined with that performed by other modules. The functions described herein as being performed by the modules 202, 204, 206, 208, and 210 also may be separated and may be performed by other modules at devices local or remote to the service provider 140.

The detection system 110 may communicate with the service provider 140 via the communication module 202. For example, the communication module 202 may receive one or more signals from the monitor module 204 and/or the service provider 140. In an exemplary embodiment, the monitor module 204 may transmit radiation data associated with an amount of radiation and/or a level of radiation the wireless device user 130 may be exposed to, to the communication module 202. The communication module 202 may transmit the radiation data to the service provider 140 to update an amount of radiation and/or a level of radiation the wireless device user 130 may be exposed to. In an exemplary embodiment, the communication module 202 may transmit the radiation data continuously, periodically, and/or intermittently. In an exemplary embodiment, the communication module 202 may transmit the radiation data to the service provider 140 every millisecond, second, minute, hour, day, or weeks, etc. The communication module 202 may transmit the radiation data automatically, iteratively or upon a request by the wireless device user 130 and/or the service provider 140. The communication module 202 may transmit the radiation data when the detection system 110 and/or the wireless device 120 are turned on or during a wireless device user initiated communications session. Also, in the event that the wireless device 120 loses services connection with the service provider 140, the communication module 202 may transmit one or more update signals when the wireless device 120 reestablishes a service connection with the service provider 140. In another exemplary embodiment, the communication module 202 may transmit the radiation data to the service provider 140 and/or the wireless device 120 to notify the service provider 140 that an amount of radiation and/or a level of radiation the wireless device user 130 may be exposed to exceeds a threshold radiation amount and/or a threshold level of radiation.

In another exemplary embodiment, the communication module 202 may communicate with the wireless device 120. The communication module 202 may transmit the radiation data to the wireless device 120 to update an amount of radiation and/or a level of radiation the wireless device user 130 may be exposed to. In an exemplary embodiment, the communication module 202 may transmit the radiation data continuously, periodically, and/or intermittently to the wireless device 120.

The service provider 140 may communicate with the detection system 110 via the communication module 202. The wireless device user 130 may access a graphical user interface provided by the service provider 140. The graphical user interface may include one or more websites and/or webpages to allow the wireless device user 130 to input user preferences. For example, the user preferences may include, but is not limited to, user name, user password, billing information, threshold level of radiation, threshold radiation amount, period of monitoring, record radiation data, update period, notification method, date, time, types of wireless device, types of services provided, transmission frequency, transmission rate, types of network, and/or other user preferences. The detection system 110 may receive the user preferences from the service provider 140 via the communication module 202. Also, the wireless device user 130 may update the user preferences via the graphical user interface provided by the service provider 140 and/or the wireless device 120, and the detection system 110 may receive the updated user preferences via the communication module 202. The communication module 202 may transfer the user preferences and/or the updated user preferences to the database module 208 and stored. In another exemplary embodiment, the communication module 202 may receive one or more radiation requests from the service provider 140 and/or the wireless device 120 to identify an amount of radiation and/or a level of radiation the wireless device user 130 may be exposed to.

The monitor module 204 may monitor an amount of radiation and/or a level of radiation the wireless device user 130 may be exposed to. The monitor module 204 may include a radiation sensor (e.g., an electromagnetic sensor) to sense an amount of radiation and/or a level of radiation the wireless device user 130 may be exposed to. The wireless device 120 may be emitting different amounts of radiation and/or a level of radiation based on a transmission condition. For example, the wireless device 120 may emit a higher amount of radiation and/or a level of radiation when the wireless device 120 is located far from a communication infrastructure (e.g., servers, routers, wireless towers, cellular towers) associated with the service provider 140 than when the wireless device 120 is located close to the communication infrastructure associated with the service provider 140. Also, the wireless device 120 may emit a higher amount of radiation and/or a level of radiation when one or more obstructions (e.g., buildings, trees, mountains) is located between the wireless device 120 and the communication infrastructure associated with the service provider 140 than when no obstructions is located between the wireless device 120 and the communication infrastructure associated with the service provider 140. The monitor module 204 may continuously, periodically, and/or intermittently monitor an amount of radiation and/or a level of radiation the wireless device user 130 may be exposed to. For example, the monitor module 204 may continuously monitor an amount of radiation and/or a level of radiation the wireless device user 130 may be exposed to, once the detection system 110 is turned on. Also, the monitor module 204 may monitor an amount of radiation and/or a level of radiation the wireless device user 130 may be exposed to during a call session. The monitor module 204 may monitor an amount of radiation and/or a level of radiation the wireless device user 130 may be exposed to during a time period (e.g., 8 a.m. to 5 p.m.). The monitor module 204 may monitor an amount of radiation and/or a level of radiation the wireless device user 130 may be exposed to iteratively (e.g., every second, minute, hour, day). Therefore, the monitor module 204 may determine an amount of radiation and/or a level of radiation the wireless device user 130 may be exposed to under various transmission conditions.

In an exemplary embodiment, the monitor module 204 may be coupled to a transmission and/or a reception portion of the wireless device 120. The monitor module 204 may determine an amount of radiation and/or a level of radiation the wireless device user 130 may be exposed based at least in part on the transmission signal strength and/or the reception signal strength. In an exemplary embodiment, the wireless device user 130 may be exposed to a higher amount of radiation and/or a level of radiation in the event of high transmission signal strength and/or reception signal strength. Monitor module 204 may sense and/or detect a transmission signal strength and/or reception signal strength.

Also, the monitor module 204 may include a proximate sensor to determine a distance between the wireless device 120 and the wireless device user 130. The monitor module 204 may determine an amount of radiation and/or a level of radiation the wireless device user 130 may be exposed to base at least in part on the distance between the wireless device 120 and the wireless device user 130. For example, when the wireless device 120 is held far (e.g., in hand away from the body) from the wireless device user 130, the wireless device user 130 may be exposed to less radiation when the wireless device 120 is held close (e.g., held against the body) to the wireless device user 130. In an exemplary embodiment, the wireless device user 130 may be exposed to a higher amount of radiation and/or a level of radiation when the wireless device 120 is held against the head of the wireless device user 130 compared to when the wireless device 120 is held away from the body of the wireless device user 130. Therefore, the monitor module 204 may determine an amount of radiation and/or a level of radiation the wireless device user 130 may be exposed to base at least in part on transmission signal strength, reception signal strength, and/or a distance between the wireless device 120 and the wireless device user 130.

Also, the monitor module 204 may determine an amount of radiation and/or a level of radiation the wireless device user 130 may be exposed to base at least in part on an operation mode of the wireless device 120. For example, the monitor module 204 may determine an amount of radiation and/or a level of radiation the wireless device user 130 may be exposed to base at least in part on a power setting associated with the wireless device 120. For example, the power setting associated with the wireless device 120 may include, but is not limited to, active setting (e.g., transmitting and/or receiving signals), inactive setting (e.g., not transmitting and/or receiving signals), power saving setting (e.g., transmitting and/or receiving at a reduced power level), and/or other power setting associated with the wireless device 120. In an exemplary embodiment, the monitor module 204 may determine that the wireless device user 130 may be exposed to high amount of radiation and/or a level of radiation when the wireless device 120 is in the active setting. The monitor module 204 may determine that the wireless device user 130 may be exposed to a low amount of radiation and/or a level of radiation when the wireless device 120 is in the inactive setting. While, the monitor module 204 may determine that the wireless device user 130 may be exposed to medium amount of radiation and/or level of radiation when the wireless device 120 is in the power saving setting.

In an exemplary embodiment, the monitor module 204 may determine an amount of radiation and/or a level of radiation the wireless device user 130 may be exposed to base at least in part on the wireless device users' behavior. The wireless device user's behavior may include, but is not limited to, wireless device user 130 uses an internal speaker phone associated with the wireless device 120, wireless device user 130 uses an external speaker phone device and/or handfree devices associated with the wireless device 120, and/or other wireless user's behavior. For example, in the event that the wireless device user 130 uses an internal speaker phone of the wireless device 120, the wireless device user 130 may hold the wireless device 120 away from the body of the wireless device user 130 and therefore the monitor module 204 may determine that the wireless device user 130 may be exposed to less amount of radiation and/or level of radiation compared to when the wireless device 120 is held close to the body of the wireless device user 130. In the event that the wireless device user 130 uses an external speaker phone and/or handfree devices (e.g., Bluetooth devices) associated with the wireless device 120, the wireless device user 130 may hold the wireless device 120 away from the body of the wireless device user 130. The monitor module 204 may determine that the wireless device user 130 may be exposed to less amount of radiation and/or low level of radiation compared to when the wireless device 120 is held close to the body of the wireless device user 130. The external speaker phone and/or handfree devices associated with the wireless device 120 may be a wire speaker phone (e.g., headsets, earbuds/earphones) or a wireless speaker phone (e.g., Bluetooth headset/earbuds/earphones). In the event that the wireless device user 130 uses an internal or an external speaker phone and/or handfree devices associated with the wireless device 120, monitor module 204 may determine an amount of radiation and/or a level of radiation the wireless device user 130 may be exposed to based on a distance between the wireless device 120 and the wireless device user 130. As described above, the monitor module 204 may include a proximity sensor to determine a distance between the wireless device 120 and the wireless device user 130. The monitor module 204 may determine that the wireless device user 130 may be exposed to a lower amount of radiation and/or level of radiation as the wireless device 120 is held further away from the wireless device user 130.

The monitor module 204 may determine an amount of radiation and/or a level of radiation the wireless device user 130 may be exposed to base at least in part on surrounding environments associated with the wireless device user 130. For example, in the event that the wireless device user 130 is located in a shielded environment (e.g., in a car or in a building), the monitor module 204 may determine that the shielded environment may trap radiation associated with the wireless device 120 and the wireless device user 130 may be exposed to a higher amount of radiation and/or level of radiation compared to when the wireless device user 130 is located in an open environment (e.g., field, outside of car/building).

The monitor module 204 may determine an amount of radiation and/or a level of radiation the wireless device user 130 may be exposed to and transfer the radiation data to the service provider 140 via the communication module 202 and stored remotely. The monitor module 204 may transfer the radiation data associated with the wireless device user 130 to the database module 208 and stored locally. The monitor module 204 may display a radiation level the wireless device user 130 may be exposed to at various times via a display associated with the detection system 110 and/or the wireless device 120. For example, the monitor module 204 may display (not shown) the radiation level via a radiation icon, radiation meter, radiation bar, and/or other methods of demonstrating a level of radiation. Also, the monitor module 204 may transfer the radiation data associated with the wireless device user 130 to the notification module 206 for further processing.

The notification module 206 may include one or more processors and/or computers codes to execute one or more processing functions. For example, the notification module 206 may compare the amount of radiation and/or a level of radiation the wireless device user 130 may be exposed to with a threshold amount of radiation and/or a threshold level of radiation associated with a period of time. For example, the wireless device user 130 may set the threshold amount of radiation and/or a threshold level of radiation for one day to an “X” amount of radiation and/or level of radiation. Also, the wireless device user 130 may set the threshold amount of radiation and/or the threshold level of radiation for a call session to a “Y” amount of radiation and/or level of radiation. In the event that the notification module 206 determines that the amount of radiation and/or the level of radiation the wireless device user 130 may be exposed to exceeds either the “X” amount of radiation and/or level of radiation for a day or the “Y” amount of radiation and/or level of radiation for a call session, an alert message may be sent to the wireless device user 130 and/or the service provider 140. The notification module 206 may compare the amount of radiation and/or the level of radiation the wireless device user 130 may be exposed to with a threshold level of radiation at a point in time. For example, the wireless device user 130 may set the threshold level of radiation at “Z” level of radiation. In the event that the notification module 206 determines that at anytime the level of radiation the wireless device user 130 may be exposed to exceeds the “Z” level of radiation, an alert message may be sent to the wireless device user 130.

In an exemplary embodiment, the notification module 206 may transmit an alert message to the presentation module 210. The presentation module 210 may present the alert message to the wireless device user 130 via the wireless device 120. The alert message may be an audio message (e.g., audio recording, beeps, Geiger counter sound, and/or rings), a visual message (e.g., flashes, display meters, display bars, display messages, text message, and/or electronic mail), a haptic message (e.g., vibration) and/or other methods of alert the wireless device user 130. For example, the alert message may be an audio message, the notification module 206 may transmit the audio alert message to a speaker (not shown) associated with the wireless device 120 and/or a speaker (not shown) associated with the detection system 110. For example, the alert message may be a visual message, the notification module 206 may transmit the visual alert message to a display (not shown) associated with the wireless device 120 and/or a display (not shown) associated with the detection system 110. The alert message may be a haptic message, the notification module 206 may transmit the haptic alert message to cause the wireless device 120 and/or the detection system 110 to vibrate. The presentation module 210 may include an Application Programming Interface (API) to interact with the wireless device user 130. The presentation module 210 may present an alert message to the wireless device user 130. Also, the presentation module 210 may display an amount of radiation and/or a level of radiation the wireless device user 130 may be exposed to.

The notification module 206 may be in communication with the monitor module 204, the database module 208, the presentation module 210 and/or the service provider 140 (e.g., via the communication module 202). For example, the notification module 206 may receive radiation data associated with the wireless device user 130 from the monitor module 204 and process the radiation data associated with the wireless device user 130. The notification module 206 may obtain the threshold amount of radiation and/or the threshold level of radiation from the database module 208 and/or the service provider 140 (e.g., via the communication module 202). For example, the notification module 206 may obtain the threshold amount of radiation and/or the threshold level of radiation stored locally from the database module 208 in order to reduce traffic congestion over the network 150. The notification module 206 may obtain the threshold amount of radiation and/or the threshold level of radiation from the service provider 140 via the communication module 202 when the network 150 has free bandwidth. In addition, the notification module 206 may transmit one or more notification signals to the service provider 140 to notify the service provider 140 and/or the database module 208 that an amount of radiation and/or a level of radiation the wireless device user 130 may be exposed to exceeds a threshold amount of radiation and/or a threshold level of radiation, respectively. Also, the notification module 206 may transmit one or more notification signals to the service provider 140 to notify the wireless device 120, the service provider 140, and/or the database module 208 that a level of radiation the wireless device user 130 may be exposed to exceeds a threshold level of radiation.

The database module 208 may be in communication with the monitor module 204, the notification module 206, the presentation module 210 and/or the service provider 140 (e.g., via the communication module 202). The database module 208 may store and/or manage radiation data associated with the wireless device user 130 transmitted from the monitor module 204. The database module 208 may provide an interface, e.g., a uniform interface, for other modules within the detection system 110 and may write, read, and search radiation data in one or more repositories or databases (not shown). The database module 208 may also perform other functions, such as, but is not limited to, concurrent access, event notification, backup and/or archive functions. Also, due to limited amount of storing space the database module 208 may compress, store, transfer and/or discard the radiation data associated with the wireless device user 130 stored within, after a period of time, e.g., a month.

The database module 208 may be in communication with the service provider 140 via the communication module 202. The service provider 140 may transfer user preferences to the database module 208 via the communication module 202. Also, the service provider 140 may provide updates of user preferences to the database module 208 via the communication module 202, continuously or periodically. The service provider 140 may provide one or more websites and/or webpages for the wireless device user 130 to enter the user preferences. In an exemplary embodiment, wireless device user 130 may have a plurality of wireless devices 120. The service provider 140 may transfer the user preferences entered by the wireless device user 130 to the plurality of wireless devices 120 that are associated with the wireless device user 130. Also, the wireless device user 130 may enter different user preferences for different wireless devices 120. The service provider 140 may provide different user preferences associated with different wireless devices 120 to the database modules 208 associated with different wireless devices 120.

In another exemplary embodiment, a wireless device user 130 may input and/or update user preferences via an input (not shown) associated with the detection system 110 and/or the wireless device 120. For example, the detection system 110 may include numeric and/or alphabetic keypads to input and/or update user preferences associated with the wireless device user 130. The inputted and/or updated user preferences from the wireless device user 130 may be stored in the database module 208. The database module 208 may transfer the inputted and/or updated user preferences to the service provider 140 via the communication module 202. Also, the wireless device user 130 may utilize an input (not shown) associated with the wireless device 120 to input and/or update user preferences. For example, the wireless device 120 may include numeric and/or alphabetic keypads and/or speech recognition to input and/or update user preferences associated with the wireless device user 130. The inputted and/or updated user preferences from the wireless device user 130 may be stored in the database module 208. The database module 208 may transfer the inputted and/or updated user preferences to the service provider 140 via the communication module 202.

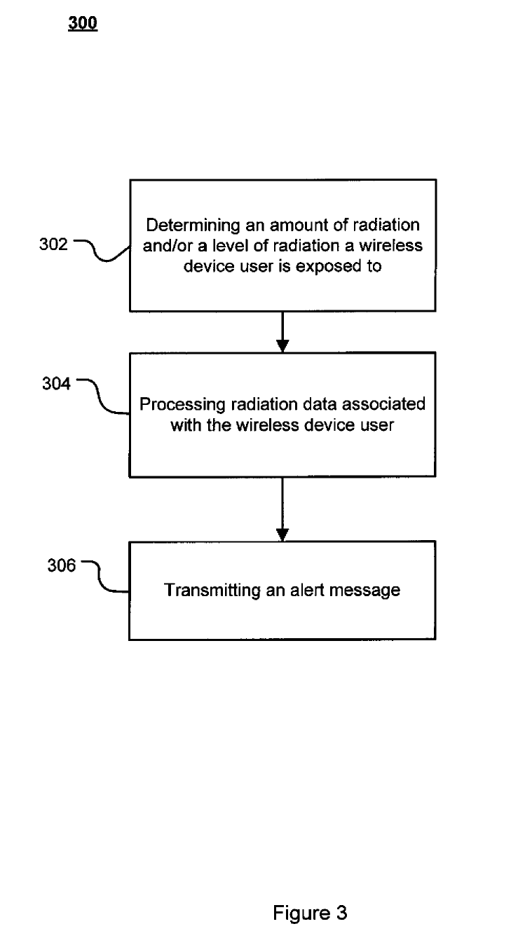

FIG. 3 illustrates a flowchart for monitoring and/or notifying wireless device users of radiation exposure, in accordance with exemplary embodiments. This exemplary method is provided by way of example, as there are a variety of ways to carry out methods disclosed herein. The method 300 shown in FIG. 3 can be executed or otherwise performed by one or a combination of various systems. The method 300 is described below as carried out by the system 100 shown in FIGS. 1 and 2 by way of example, and various elements of the system 100 are referenced in explaining the example method of FIG. 3. Each block shown in FIG. 3 represents one or more processes, methods, or subroutines carried in the exemplary method 300. The method 300 may begin at block 302.

At block 302, an amount of radiation and/or a level of radiation a wireless device user 130 may be exposed to is determined. In an exemplary embodiment, the detection system 110 may include a monitor module 204 having one or more radiation sensors which may determine an amount and/or a level of radiation the wireless device user 130 may be exposed. For example, the detection system 110 may determine an amount of radiation the wireless device user 130 may be exposed to in a period of time. Also, the detection system 110 may determine a radiation level the wireless device user 130 may be exposed at an instant in time. The radiation data (e.g., an amount of radiation and/or a level of radiation) associated with the wireless device user 130 may be transferred to a database module 208 and/or a service provider 140 and stored. The radiation data associated with the wireless device user 130 may be transferred to a notification module 206. In another exemplary embodiment, the monitor module 204 may display an amount of radiation and/or a level of radiation the wireless device user 130 may be exposed to at various periods of time and/or instances of times via a display associated with the detection system 110 and/or the wireless device 120. The method of 300 may proceed to block 304.

At block 304, the radiation data (e.g., an amount of radiation and/or a level of radiation) associated with the wireless device user 130 may be processed. In an exemplary embodiment, the notification module 206 may process the radiation data provided by the monitor module 204. The notification module 206 may compare an amount of radiation the wireless device user 130 may be exposed in a period of time with a threshold amount of radiation. Also, the notification module 206 may compare a level of radiation the wireless device user 130 may be exposed to in various instances of time with a threshold level of radiation. The wireless device user 130 may input the threshold amount of radiation and/or the threshold level of radiation via an input associated with the detection system 110, the wireless device 120, and/or the service provider 140. The notification module 206 may transfer the processed radiation data associated with the wireless device user 130 to the database module 208 and/or a service provider 140, where the radiation data may be stored. Also, the notification module 206 may transfer the processed radiation data associated with the wireless device user 130 to the presentation module 210 to be displayed/played/vibrated to the wireless device user 130. The method of 300 may proceed to block 306.

At block 306, in the event that the amount and/or the level of radiation the wireless device user 130 may be exposed to exceeds the threshold amount of radiation and/or the threshold level of radiation, an alert message may be sent to the wireless device user 130. For example, the alert message may be an audio message, a visual message (e.g., flashes, display meters, display bars, display messages), a haptic message (e.g., vibration) and/or other methods of alert the wireless device user 130. Also, the presentation module 210 may display the amount of radiation and/or the level of radiation the wireless device user 130 may be exposed to via the wireless device 120 and/or the service provider 140. For example, the service provider 140 may provide one or more websites and/or webpages to display the amount of radiation and/or the level of radiation the wireless device user 130 may be exposed to.

It should be appreciated that exemplary embodiments may be implemented as a method, a data processing system, or a computer program product. Accordingly, exemplary embodiments may take the form of an entirely hardware embodiment, an entirely software embodiment, or an embodiment combining software and hardware aspects. Furthermore, implementations of the exemplary embodiments may take the form of a computer program product on a computer-readable storage medium having computer-readable program instructions (e.g., computer software) embodied in the storage medium. More specifically, implementations of the exemplary embodiments may take the form of web-implemented computer software. Any suitable computer-readable storage media may be utilized including hard disks, CD-ROMs, optical storage devices, magnetic storage devices, or other similar computer readable/executable storage media.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method, comprising:
determining at least one of an amount of radiation and a level of radiation, a wireless device user is exposed to;
comparing at least one of the amount of radiation with a threshold amount of radiation and the level of radiation with a threshold level of radiation; and
transmitting an alert message based at least in part on a result of the comparison of at least one of the amount of radiation with the threshold amount of radiation and the level of radiation with the threshold level of radiation.

2. The method of claim 1, wherein the amount of radiation the wireless device user is exposed to is a total amount of radiation the wireless device user is exposed to for a period of time.

3. The method of claim 1, wherein the level of radiation the wireless device user is exposed to is a radiation level the wireless device user is exposed to for a point in time.

4. The method of claim 17 further comprises inputting at least one of the threshold amount of radiation and the threshold level of radiation via one or more websites or webpages associated with a service provider.

5. The method of claim 4, wherein inputting at least one of the threshold amount of radiation and the threshold level of radiation comprises inputting at least one of the threshold amount of radiation and the threshold level of radiation via an input associated with a wireless device.

6. The method of claim 4, wherein inputting at least one of the threshold amount of radiation and the threshold level of radiation comprises inputting at least one of the threshold amount of radiation and the threshold level of radiation via an input associated with a detection system.

7. The method of claim 1, wherein comparing at least one of the amount of radiation with a threshold amount of radiation and the level of radiation with a threshold level of radiation further comprises storing at least one of the amount of radiation and the level of radiation, the wireless device user is exposed to.

8. The method of claim 1, wherein transmitting an alert message further comprises displaying at least one of the amount of radiation and the level of radiation, the wireless device user is exposed to.

9. The method of claim 8, wherein displaying at least one of the amount of radiation and the level of radiation, the wireless device user is exposed to via one or more websites or webpages associated with a service provider.

10. The method of claim 8, wherein displaying, on the wireless device, at least one of the amount of radiation and the level of radiation, the wireless device user is exposed to.

11. The method of claim 1, wherein the alert message comprises at least one of an audio message, a visual message, and a haptic message.

12. A computer readable media comprising code to perform the steps of the methods of claim 1.

13. A system, comprising:
a detection system associated with a wireless device configured to determine at least one of an amount of radiation and a level of radiation, a user associated with the wireless device is exposed to, wherein the detection system comprises:
a database module for storing at least one of a threshold amount of radiation and a threshold level of radiation;
a monitor module for comparing at least one of the amount of radiation with the threshold amount of radiation and the level of radiation with the threshold level of radiation; and
a notification module for transmitting an alert message based at least in part on a result of the comparison of at least one of the amount of radiation with the threshold amount of radiation and the level of radiation with the threshold level of radiation.

14. The system of claim 13, wherein the detection system is integrated with the wireless device.

15. The system of claim 13, wherein the detection system is an external device coupled to the wireless device.

16. The system of claim 13, wherein the wireless device is associated with a service provider, and the service provider is in communication with the detection system.

17. The system of claim 16, wherein the service provider is configured to provide one or more websites or webpages for the user associated with the wireless device to enter at least one of a threshold amount of radiation and a threshold level of radiation.

18. The system of claim 13, wherein the detection system further comprises a communication module configured to communicate with at least one of the wireless device and a service provider.

19. The system of claim 13, wherein the monitoring module includes at least one of a electromagnetic wave sensor, a thermal sensor, a magnetic sensor, a proximity sensor, and a Geiger counter.

20. The system of claim 13, wherein the detection system further comprises a presentation module configured to cause a display of at least one of the amount of radiation and the level of radiation, the user associated with the wireless device is exposed to.

21. The system of claim 13, wherein the alert message comprises at least one of an audio message, a visual message, and a haptic message.

22. A method, comprising:
determining at least one of an amount of radiation output and a level of radiation output associated with a wireless device;
monitoring at least one of the amount of radiation output and the level of radiation output associated with the wireless device; and
transmitting an alert message to a wireless device user in the event that (i) the amount of radiation output exceeds a threshold amount of radiation, or (ii) the level of radiation output exceeds a threshold level of radiation.

23. The method of claim 22, further comprises inputting at least one of the threshold amount of radiation and the threshold level of radiation via one or more websites or webpages associated with a service provider.

24. The method of claim 22, wherein monitoring at least one of the amount of radiation output and the level of radiation output associated with the wireless device further comprises storing at least one of the amount of radiation output and the level of radiation output associated with the wireless device.

25. The method of claim 22, wherein transmitting an alert message further comprises displaying at least one of the amount of radiation output and the level of radiation output associated with the wireless device.
